(19) United States
(12) Patent Application Publication
(10) Pub. No.: US 2017/0372631 A1
(43) Pub. Date: Dec. 28, 2017

(54) Pet Management System And Methods of Use

(71) Applicants: Keith Meggs, Torrance, CA (US); Leung Chung Ha, Tai Hang (HK)

(72) Inventors: Keith Meggs, Torrance, CA (US); Leung Chung Ha, Tai Hang (HK)

(21) Appl. No.: 15/623,185

(22) Filed: Jun. 14, 2017

Related U.S. Application Data
(60) Provisional application No. 62/355,223, filed on Jun. 27, 2016.

(51) Int. Cl. G09B 9/00; G09B 5/04; G09B 5/02; G06F 17/30; A01K 13/00; G09B 19/00; A01K 11/00

(52) U.S. Cl. CPC G09B 9/00; G09B 19/00; G09B 5/04; A01K 11/006; G06F 17/30339; A01K 13/00; G09B 5/02

(57) ABSTRACT

A pet management system and associated methods are configured for assisting an at least one user in caring for and training an at least one actual pet. In at least one embodiment, a central computing system is configured for receiving and processing data related to the at least one user and associated at least one actual pet. An at least one user device is under the control of the at least one user and in selective communication with the computing system. The system is configured for first teaching the at least one user how to care for and train an at least one virtual pet, configured for simulating the qualities and behaviors of the associated at least one actual pet, so as to better ensure that the user is sufficiently prepared for and capable of subsequently caring for and training the corresponding at least one actual pet, for which the system also assists in an ongoing manner.

### RELATED APPLICATIONS

This application claims priority and is entitled to the filing date of U.S. provisional application Ser. No. 62/355,223, filed on Jun. 27, 2016. The contents of the aforementioned application are incorporated herein by reference.

### BACKGROUND

The subject of this provisional patent application relates generally to pet training and management, and more particularly to a pet management system and associated methods of use for teaching and assisting a user in caring for and training a pet.

Applicant(s) hereby incorporate herein by reference any and all patents and published patent applications cited or referred to in this application.

By way of background, pets are part of many children's lives and can provide a wealth of benefits, as a child who learns to care for an animal, and treat it kindly and patiently, may obtain invaluable social skills in learning to treat people the same way. Developing positive feelings about pets can also contribute to a child's self-esteem and self-confidence, while aiding in the development of trusting relationships with others. A good relationship with a pet can also help in developing non-verbal communication, compassion, empathy, and responsibility. With these known benefits in mind, many parents are eager to bring a pet into their family, believing that their children are ready to take on the responsibility—either solely or with the assistance and supervision of their parents—of caring for the pet. However, many times, these parents subsequently learn that their children are not ready for such responsibility, or that they themselves are unable to devote the necessary time and attention to care for the pet on their own should their children become lax in their care or lose interest. As a result, the pets suffer either by receiving inadequate attention or care, or by ultimately being given up to another family or, worse yet, an animal shelter. Thus, there is a need for a way to assist parents in preparing their children to care for and train a pet, determining when their children are ready to care for and train a pet, and subsequently assisting their children in actually caring for and training a pet. There is a similar need for a way to assist people generally (regardless of age) with caring for and training a pet.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a pet management system and associated methods configured for assisting an at least one user in caring for and training an at least one actual pet. In at least one embodiment, a central computing system is configured for receiving and processing data related to the at least one user and associated at least one actual pet, said data stored in an at least one user account containing at least one of a unique account identifier, a user table containing details related to each of the at least one user associated with the user account, and a pet table containing details related to each of the at least one actual pet associated with the user account. An at least one user device is under the control of the at least one user and in selective communication with the computing system. The system is configured for automatically generating an at least one virtual pet based on the data related to the at least one actual pet contained in the pet table of the associated user account, with the at least one virtual pet being configured for simulating the qualities and behaviors of the associated at least one actual pet. Additionally, the system automatically generates each of a care schedule and training schedule based on the data contained in at least one of the pet table and user table of the associated user account. The user is periodically prompted, via the associated at least one user device, to complete at least one care- or training-related task in connection with the at least one virtual pet based on the respective care or training schedule. Upon the at least one user acquiring a sufficient amount of knowledge and experience in caring for the at least one virtual pet, the system begins periodically prompting the at least one user, via the associated at least one user device, to complete at least one care- or training-related task in connection with the corresponding at least one actual pet based on the respective care or training schedule. Thus, the system is configured for first teaching the at least one user how to care for and train the at least one virtual pet so as to better ensure that the user is sufficiently prepared for and capable of subsequently caring for the corresponding at least one actual pet, for which the system also assists in an ongoing manner.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary pet management system, in accordance with at least one embodiment;

FIGS. 2-5 are architecture diagrams of an exemplary user account, in accordance with at least one embodiment; and

FIG. 6 is a flow diagram of an exemplary method for administering the exemplary pet management system, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

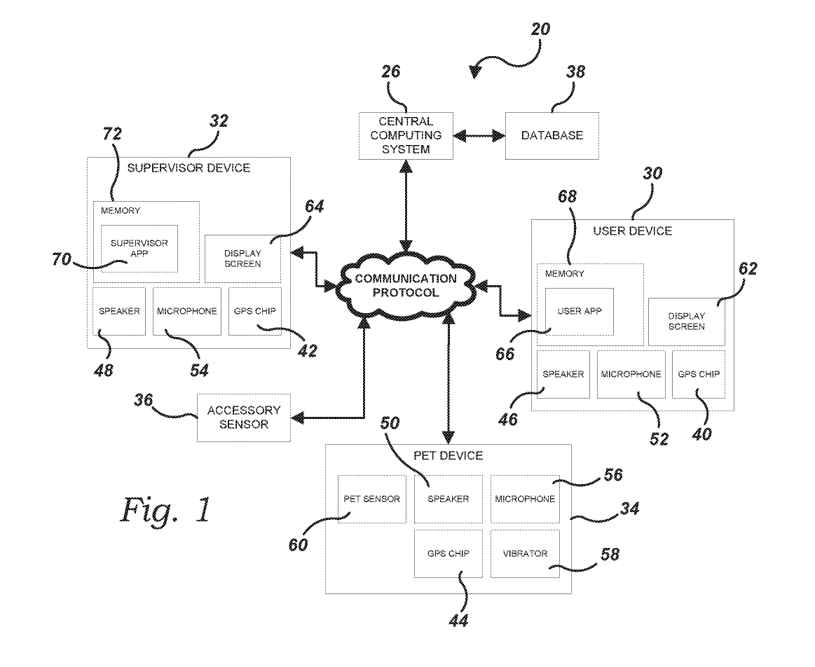

Turning now to FIG. 1, there is shown a simplified schematic view of an exemplary pet management system 20 configured for teaching and assisting an at least one user 22 in caring for and training an at least one pet 24, in accordance with at least one embodiment. The system 20 provides, in at least one embodiment, a central computing system 26 configured for receiving and processing data related to the at least one user 22 and associated at least one pet 24, along with an associated at least one supervisor 28, as discussed further below. In at least one embodiment, the system 20 further provides an at least one user device 30, an at least one supervisor device 32, an at least one pet device 34, and an at least one accessory sensor 36 each in selective communication with the computing system 26. In at least one embodiment, as discussed further below, the at least one user device 30, supervisor device 32, pet device 34 and accessory sensor 36 are also in selective communication with one another.

In at least one embodiment, as discussed further below, the at least one user device 30 in the possession or control of a user 22 who is desirous of utilizing the system 20 for learning how to care for and train a pet 24, with the user device 30 being configured for teaching the user 22 how to care for and train a virtual pet, and subsequently assisting the user 22 with caring for and training the actual pet 24. It should be noted that, in at least one embodiment, the user device 30 may be in the possession of an adult who is desirous of utilizing the system 20 for learning how to care for and train a pet 24. In at least one embodiment, as also discussed further below, the at least one supervisor device 32 is in the possession or control of a supervisor 28 associated with the user 22 who is desirous of supervising the user's 22 interaction with the system 20 and the pet 24, with the supervisor device 32 being configured for allowing the supervisor 28 to monitor the status and progress of the user's 22 care for both the virtual pet and actual pet 24. In at least one embodiment, as also discussed further below, the at least one pet device 34 is attached to or otherwise worn by the pet 24, with the pet device 34 being configured for assisting the user 22 with caring for and training the pet 24. In at least one embodiment, as also discussed further below, the at least one accessory sensor 36 is configured for being selectively attached to desired objects for remotely monitoring the pet's 24 interaction with those objects.

Additionally, in at least one embodiment, an at least one database 38 is in communication with the computing system 26 and configured for selectively storing said data related to the at least one user 22, pet 24 and supervisor 28. It should be noted that, in at least one embodiment, the computing system 26 and database 38 are one and the same—as such, it is intended that those terms as used herein are to be interchangeable with one another. In at least one embodiment, the computing system 26 and database 38 are omitted, such that the system 20 and associated methods described herein are implemented solely through at least one of the at least one user device 30, supervisor device 32 and pet device 34—thus, any methods or functionality described herein as being carried out by the computing system 26 or database 38 may, in at least one embodiment, also be carried out by at least one of the at least one user device 30, supervisor device 32 and pet device 34, regardless of whether such embodiments nevertheless incorporate the computing system 26 and/or database 38. In at least one further embodiment, one or more of the at least one supervisor device 32, pet device 34, and accessory sensor 36 may also be omitted.

At the outset, it should be noted that the respective communication between each of the computing system 26, at least one user device 30, at least one supervisor device 32, at least one pet device 34, at least one accessory sensor 36, and at least one database 38 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. It should also be noted that the terms “user device” and “supervisor device” are intended to include any type of computing or electronic device, now known or later developed, capable of communicating with at least one of the computing system 26, at least one user device 30, at least one supervisor device 32, at least one pet device 34, and at least one accessory sensor 36—such as desktop computers, mobile phones, smartphones, laptop computers, tablet computers, personal data assistants, gaming devices, wearable devices, etc. As such, the system 20 should not be read as being limited to use with any one particular type of computing or electronic device, even though certain exemplary devices may be mentioned or shown herein for illustrative purposes. It should be noted that, in at least one embodiment, the term “supervisor” is intended to generally include any person who is responsible—either permanently or temporarily—for caring for or otherwise supervising the at least one user 22. Additionally, in at least one embodiment, the term “user” is intended to generally include any person of any age and/or mental capacity that requires the supervision of another person (i.e., the supervisor 28); though, in at least one further embodiment, the term “user” is intended to generally include any person—regardless of age or mental capacity, or whether a supervisor 28 is required—that is desirous of utilizing the system 20 to obtain the necessary assistance with caring for and training the at least one pet 24. Furthermore, in at least one embodiment, the term “pet” is intended to generally include any type of domesticated animal under the care of the at least one user 22 or associated supervisor 28—even though certain types of animals (such as dogs) may be mentioned or shown herein for illustrative purposes.

With continued reference to FIG. 1, in the exemplary embodiment, each of the computing system 26, at least one user device 30, at least one supervisor device 32, at least one pet device 34, at least one accessory sensor 36, and at least one database 38 contains the hardware and software necessary to carry out the exemplary methods for administering the pet management system 20, as described herein. Furthermore, in at least one embodiment, the computing system 26 comprises a plurality of computing devices selectively working in concert with one another to carry out the exemplary methods for administering the pet management system 20, as described herein. In at least one embodiment, the user device 30 is configured as a wearable device, such as a smartwatch for example. Similarly, in at least one embodiment, the pet device 34 is also configured as a wearable device, such as a collar for example.

In at least one embodiment, as discussed further below, the at least one user device 30, supervisor device 32 and pet device 34 each provides an at least one global positioning system (“GPS”) chip 40, 42 and 44 for assisting in providing the computing system 26 with the geographic location of the respective user 22, supervisor 28 and pet 24 in possession of each said device 30, 32 and 34. As such, in at least one embodiment, the user 22 is able to determine the location of the pet 24 at any given time, while the supervisor 28 is similarly able to determine the location of both the user 22 and the pet 24, with appropriate alerts being provided via the appropriate device 30 or 32 should either the user 22 or pet 24 travel beyond a specified geographic range. Additionally, in at least one embodiment, the at least one user device 30, supervisor device 32 and pet device 34 each provides an at least one speaker 46, 48 and 50, and an at least one microphone 52, 54 and 56, thereby allowing for audio-based communication between the respective devices 30, 32 and 34—such as for allowing the user 22 or supervisor 28 to remotely transmit audible commands to the pet 24, for example. Relatedly, in at least one embodiment, the at least one pet device 34 provides an at least one vibrator 58 configured for providing physical feedback to the pet 24 in the form of pleasing vibrations and pulse patterns. These vibrations may be utilized both as part of the commands that the user 22 or supervisor 28 transmits to the pet 24 via the respective device 30 or 32 (either in combination with, or in lieu of, the audible commands), and as part of the positive reinforcement provided to the pet 24 for successfully completing a task or obeying a command, as discussed further below. In at least one embodiment, the at least one pet device 34 also provides at least one pet sensor 60 capable of monitoring various details related to the pet 24—including but not limited to the pet's 24 pulse, the pet's 24 breathing rate, the pet's 24 location, the pet's 24 physical orientation (i.e., standing, lying down, etc.), the pet's 24 movement (i.e., stationary, walking, running, etc.), the pet's 24 speed, etc.—with such details being selectively transmitted to at least of one the computing system 26, the at least one user device 30, and the at least one supervisor device 32. In at least one embodiment, the at least one user device 30 and supervisor device 32 each further provides an at least one display screen 62 and 64 for providing an at least one graphical user interface to assist the respective user 22 and supervisor 28 in possession of each said device 30 and 32 to utilize the various functions provided by the system 20. In at least one embodiment, the at least one display screen 62 and 64 is a touchscreen.

In at least one embodiment, as mentioned above and discussed further below, the at least one accessory sensor 36 is configured for being selectively attached, or positioned proximal, to desired objects for remotely monitoring the pet's 24 interaction with those objects. In at least one such embodiment, the accessory sensor 36 is an optical sensor, such as proximity or motion sensor for example. In at least one further embodiment, the accessory sensor 36 utilizes near field communication (“NFC”). In at least one further embodiment, the accessory sensor 36 utilizes radio frequency identification (“RFID”). In still further embodiments, any other types of sensors, now known or later developed, capable of being selectively attached, or positioned proximal, to desired objects for remotely monitoring the pet's 24 interaction with those objects, may be substituted. Thus, the accessory sensor 36 is capable of being attached to the pet's 24 food dish or pet door, for example, thereby notifying the user device 30 and/or supervisor device 32 whenever the pet 24 uses the food dish or dog door, which can prove useful when housebreaking the pet 24 or monitoring the pet's 24 eating habits. In another example, the accessory sensor 36 may be attached to a couch, chair, or other location where the pet's 24 presence has been prohibited, thereby notifying the user device 30 and/or supervisor device 32 whenever the pet 24 disobeys such a command.

With continued reference to FIG. 1, in at least one embodiment, the at least one user device 30 provides a user application 66 residing locally in memory 68 on the user device 30, the user application 66 being configured for selectively communicating with at least one of the at least one supervisor device 32, at least one pet device 34, at least one accessory sensor 36, and the computing system 26, as discussed further below. Similarly, in at least one embodiment, the at least one supervisor device 32 provides a supervisor application 70 residing locally in memory 72 on the supervisor device 32, the supervisor application 70 being configured for selectively communicating with at least one of the at least one user device 30, at least one pet device 34, at least one accessory sensor 36, and the computing system 26, as discussed further below. It should be noted that the term “memory” is intended to include any type of electronic storage medium (or combination of storage mediums) now known or later developed, such as local hard drives, RAM, flash memory, secure digital (“SD”) cards, external storage devices, network or cloud storage devices, integrated circuits, etc.

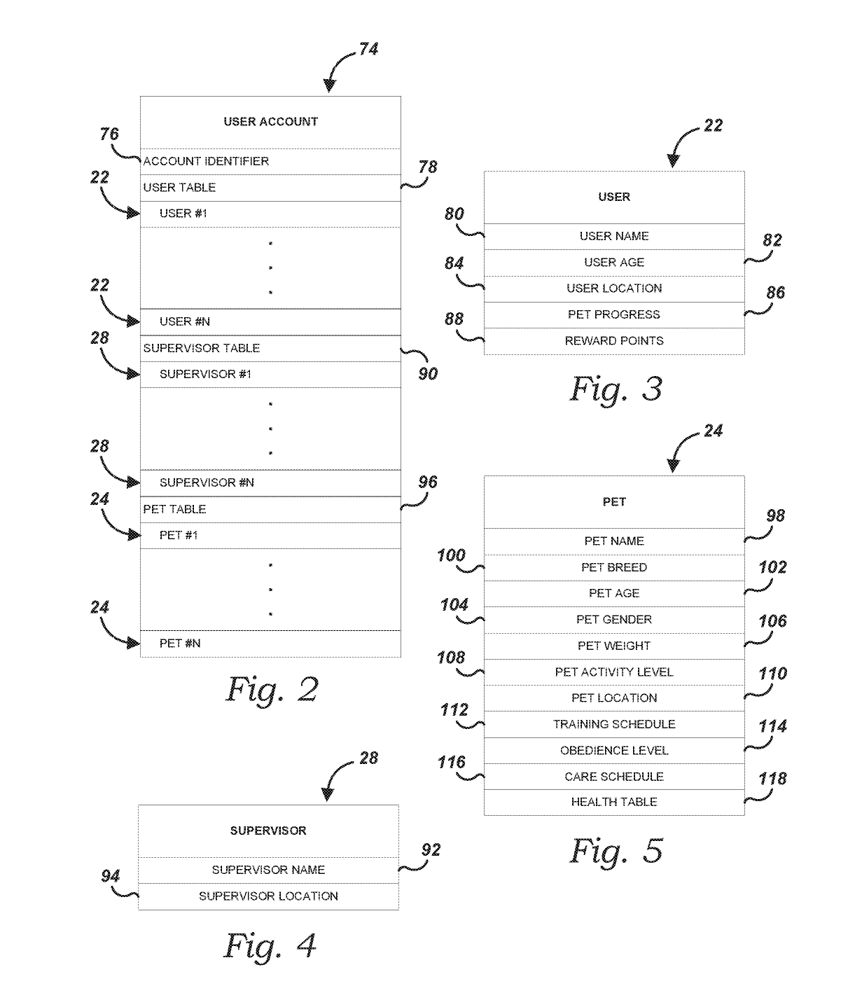

In at least one embodiment, as illustrated in the architecture diagrams of FIGS. 2-5, the computing system 26—or the at least one database 30—stores and manages a user account 74 for each user 22 containing various details related to the user 22 and associated at least one pet 24, along with an associated at least one supervisor 28. In at least one embodiment, a given user account 74 may contain details related to a plurality of users 22 where, for example, a given pet 24 is cared for by more than one child (such as siblings). In a bit more detail, in at least one embodiment, each user account 74 contains at least one of a unique account identifier 76 (such as an alphanumeric username, for example), a user table 78 containing details related to each of the at least one user 22 associated with the user account 74 (such as a user name 80, user age 82, user location 84, pet progress 86, and reward points 88, for example), a supervisor table 90 containing details related to each of the at least one supervisor 28 associated with the user account 74 (such as a supervisor name 92 and supervisor location 94, for example), and a pet table 96 containing details related to each of the at least one pet 24 associated with the user account 74 (such as a pet name 98, pet breed 100, pet age 102, pet gender 104, pet weight 106, pet activity level 108, pet location 110, training schedule 112, obedience level 114, care schedule 116 and a health table 118, for example). It should be noted that while the term “table” is used herein to describe certain exemplary data structures, in at least one embodiment, any other suitable data type or data structure, or combinations thereof, now known or later developed, capable of storing the appropriate data, may be substituted. Thus, the present invention should not be read as being so limited.

As mentioned above, in at least one embodiment, the system 20 is configured for teaching and assisting the at least one user 22 in caring for and training the at least one pet 24. In at least one such embodiment, the system 20 is configured for first teaching the user 22 how to care for and train a virtual pet (so as to better ensure that the user 22 is sufficiently capable of caring for the actual pet 24), and subsequently assisting the user 22 with caring for and training the actual pet 24. Furthermore, given the wide range of different types of pets, training regimens, and care regimens that the system 20 may be configured to assist with, the system 20 may be utilized in a variety of contexts. As such, the system 20 and associated methods described herein should not be read as being so limited. Instead, the system 20 and associated methods described herein are provided for illustrative purposes only in order to facilitate a more complete understanding of representative embodiments now contemplated. These examples are intended to be a mere subset of all possible contexts in which the system 20 may be utilized. Ultimately, the system 20 may be utilized in virtually any context where learning how to care for and train a pet 24 is desired—both by users 22 themselves as well as supervisors 28.

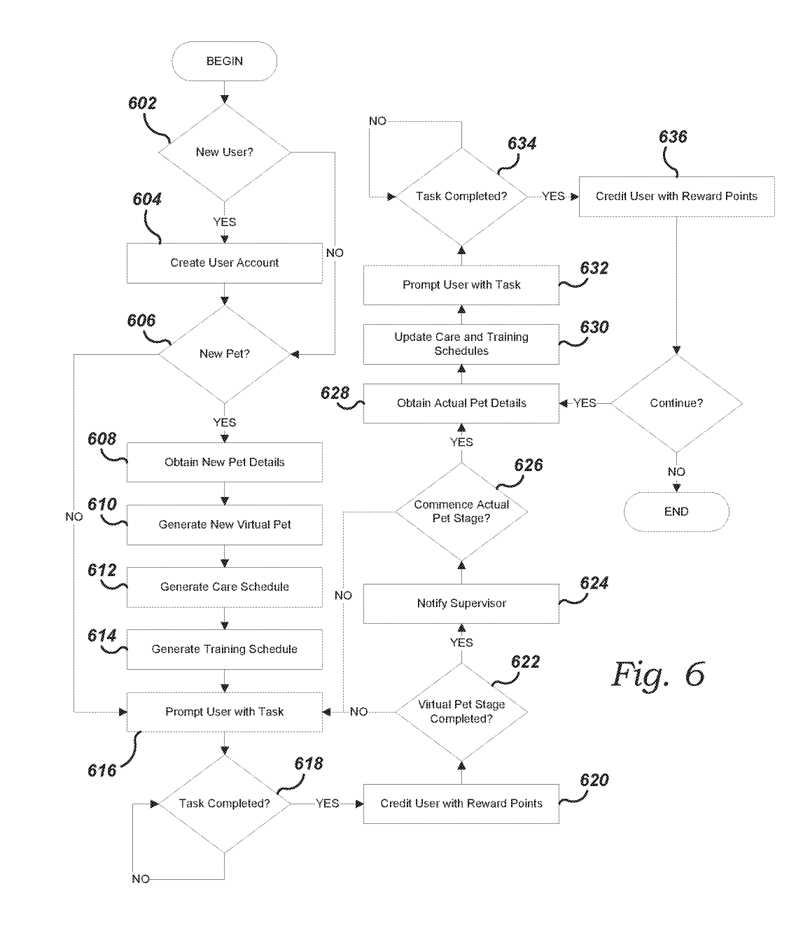

In at least one embodiment, as illustrated in the flow diagram of FIG. 6, through either the user application 66 or supervisor application 70 residing either locally in memory 68 or 72 on the respective device 30 or 32 or remotely on the computing system 26 and/or database 38, upon the associated user 22 and/or supervisor 28 desiring to utilize the system 20 to learn how to train and care for an at least one pet 24, the computing system 26 first determines whether the associated user 22 and/or supervisor 28 is new to the system 20 (602). If the associated user 22 and/or supervisor 28 is new, they are required to properly register a new user account 74 with the computing system 26 via the user device 30 or supervisor device 32 (604)—or, alternatively, via any other computing or electronic device capable of communicating with the computing system 26. As part of the registration process, the user 22 and/or supervisor 28 is asked to provide select details related to at least one of the user 22 and supervisor 28 (as discussed above), with those details being stored in the user table 78 and supervisor table 90, respectively, of the associated user account 74. Upon the user 22 and/or supervisor 28 desiring to begin caring for a new pet 24 using the system 20 (606), the user 22 and/or supervisor 28 is asked to provide select details related to the at least one new pet 24 (as discussed above), with those details being store in the pet table 96 of the associated user account 74 (608). In addition to details such as pet name 98, pet breed 100, pet age 102, pet gender 104, pet weight 106, pet activity level 108 (i.e., sedentary, moderately active, very active, etc.), the pet table 96 may contain further health-related data in the associated health table 118, including but not limited to current vaccinations, current medical conditions, current dietary restrictions, medical history, etc. In at least one embodiment, where the user 22 and/or supervisor 28 do not yet own an actual pet 24, they are encouraged to provide hypothetical information that roughly corresponds to the actual pet 24 that they hope to obtain.

With continued reference to FIG. 6, upon the necessary pet-related information being provided, a virtual pet is automatically generated having substantially the same characteristics as the data contained in the associated pet table 96 (610). In other words, the virtual pet is configured for simulating the physical qualities and typical behaviors as the actual pet 24. In this way, the user 22 is able to experience what is required to properly train and care for the actual pet 24 through first interacting with the virtual pet. In at least one embodiment, the virtual pet is viewable via the display screen 62 of the at least one user device 30. In at least one further embodiment, the virtual pet is also viewable via the display screen 64 of the at least one supervisor device 32. In addition to automatically generating the virtual pet, the care schedule 116 is also automatically generated based on the data contained in at least one of the associated pet table 96 and user table 78 (612), the care schedule 116 being configured for providing the user 22 with guidance regarding various care-related tasks, including but not limited to regularly providing the virtual pet with pre-determined amounts of food and water (based on the data contained in the associated pet table 96), regularly providing the virtual pet with a pre-determined amount of exercise (through playing with and/or walking the virtual pet), allowing the virtual pet to urinate and defecate as needed and subsequently cleaning up after the virtual pet, allowing the virtual pet to sleep as needed, regularly grooming the virtual pet, periodically taking the virtual pet to a virtual veterinarian, and administering any necessary medications to the virtual pet. Again, in at least one embodiment, the care schedule 116 is automatically tailored to accommodate the virtual pet (and, in turn, the actual pet 24) based on the data contained in the associated pet table 96. Thus, for example, the amount of food (and frequency of meals) for the virtual pet is automatically adjusted based on at least one of the associated pet breed 100, pet age 102, pet gender 104, pet weight 106, pet activity level 108. In at least one embodiment, the care schedule 116 is further tailored to accommodate the relative abilities of the user 22 based on the data contained in the associated user table 78—particularly, the user age 82. Thus, for example, if the user 22 is too young to administer medications, the care schedule 116 may omit such tasks. In at least one embodiment, the training schedule 112 is also automatically generated based on the data contained in at least one of the associated pet table 96 and user table 78 (614), the training schedule 112 being configured for providing the user 22 with guidance regarding various training-related tasks, including but not limited to sitting, staying, laying down, rolling over, shaking, barking, and fetching. Given that the virtual pet is merely a digital simulation provided through the at least one user device 30, the process of completing each of the various tasks contained in the care schedule 116 and training schedule 112 is also simulated—for example, by the user 22 providing specified inputs via the user device 30 intended to represent each such task.

In at least one embodiment, with the virtual pet created, along with the associated care schedule 116 and training schedule 112, the user application 66 periodically prompts the user 22 to complete one or more tasks via the user device 30—based on one or both of the care schedule 116 and training schedule 112—and monitors the user's 22 compliance with each such task (616). In at least one embodiment, upon the user 22 completing a given task successfully (618), the user 22 is credited with an appropriate number of reward points 88 (620), which are selectively redeemable by the user 22 for various rewards. In at least one such embodiment, the rewards are various virtual items provided through the system 20, such as virtual toys or clothes for the virtual pet, for example. In at least one further embodiment, the rewards are real items, such as real toys or clothes, or even gift cards, for example. In still further embodiments, the rewards may be any other item—real or virtual—now know or later developed. In at least one embodiment, the pet progress 86 associated with the user 22 is a numerical value that increases as tasks are successfully completed. As the user 22 continues to care for and train the virtual pet, the at least one supervisor 28 is able to monitor the user's 22 progress through the at least one supervisor device 32.

Upon the user application 66 determining that the user 22 has acquired a sufficient amount of knowledge and experience in caring for the virtual pet (622)—for example, by caring for and training the virtual pet for a pre-determined amount of time, or by accumulating a pre-determined amount of reward points, or by the associated pet progress 86 of the user 22 reaching a pre-determined level, or by the associated obedience level 114 of the virtual pet reaching a pre-determined level—the at least one supervisor 28 is notified via the at least one supervisor device 32 and advised that the user 22 is ready to care for and train the actual pet 24 (624). Should the at least one supervisor 28 agree and allow the user 22 to begin caring for and training the actual pet 24 (626), the data contained in the associated pet table 96 is updated as needed to correspond to the actual pet 24 (628), and the care schedule 116 and training schedule 112 are similarly adjusted automatically to accommodate the actual pet 24 (630). The user application 66 then periodically prompts the user 22 to complete one or more tasks via the user device 30—based on one or both of the care schedule 116 and training schedule 112—and monitors the user's 22 compliance with each such task (632). In at least one embodiment, depending on the relative abilities of the user 22 (based on user age 82 or other factors), the care schedule 116 and/or training schedule 112 may include certain tasks that must be carried out by the at least one supervisor 28 instead—such as administering medications to the actual pet 24, for example. For any such tasks, the supervisor application 70 prompts the supervisor 28 to complete such tasks accordingly. In at least embodiment, the user 22 is required to manually confirm via the user application 66 that a given task has been completed, since the tasks are now being performed on the actual pet 24. In at least one further embodiment, the at least one accessory sensor 36 may be positioned and configured for automatically determining whether certain tasks have been completed—such as being positioned in a food dish for determining when the dish is filled with food, for example—and automatically notifying the user application 66 accordingly. In at least one further embodiment, the user device 30 may be configured for automatically determining whether certain tasks have been completed—such as determining that the actual pet 24 has been taken for a walk based on data obtained from the GPS chip 40 and 44 of at least one of the user device 30 and pet device 36, for example—and automatically notifying the user application 66 accordingly. In at least one embodiment, upon the user 22 completing a given task successfully (634), the user 22 is credited with an appropriate number of selectively redeemable reward points 88 (636). As the user 22 continues to care for and train the actual pet 24, the at least one supervisor 28 is able to monitor the user's 22 progress through the at least one supervisor device 32. Additionally, in at least one embodiment, as the actual pet 24 ages (such that the needs of the actual pet 24 may change over time), the data contained in the associated pet table 96 is updated as needed to correspond to the actual pet 24 (628), and the care schedule 116 and training schedule 112 are similarly adjusted automatically to accommodate the actual pet 24 (630). Thus, using a system of positive reinforcement, the user application 66 automatically establishes a daily care and training schedule for the user 22 to follow and rewards the user 22 for doing so. In at least one further embodiment, as the user 22 performs care- and training-related tasks in connection with the virtual pet, the system 20 simultaneously performs the same care- and training-related tasks in connection with the actual pet 24, such that the user 22 indirectly cares for and trains the actual pet 24 while still interacting with the virtual pet.

Aspects of the present specification may also be described as follows:

1. A method for administering a pet management system for assisting an at least one user in caring for and training an at least one actual pet, the method comprising the steps of: implementing a central computing system configured for receiving and processing data related to the at least one user and associated at least one actual pet; implementing a user application residing in memory on an at least one user device under the control of the at least one user, the at least one user device in selective communication with the computing system; establishing a user account associated with a one of the at least one user and associated at least one actual pet, the user account containing at least one of a unique account identifier, a user table containing details related to each of the at least one user associated with the user account, and a pet table containing details related to each of the at least one actual pet associated with the user account; and upon a one of the at least one user desiring to care for and train the at least one actual pet: obtaining data related to the at least one user to be stored in the user table of the associated user account; obtaining data related to the at least one actual pet to be stored in the pet table of the associated user account; automatically generating an at least one virtual pet based on the data related to the at least one actual pet contained in the pet table of the associated user account, the at least one virtual pet configured for simulating the qualities and behaviors of the associated at least one actual pet; automatically generating a care schedule based on the data contained in at least one of the pet table and user table of the associated user account, the care schedule being configured for providing the at least one user with guidance regarding various care-related tasks; automatically generating a training schedule based on the data contained in at least one of the pet table and user table of the associated user account, the training schedule being configured for providing the at least one user with guidance regarding various training-related tasks; periodically prompting the at least one user, via the associated at least one user device, to complete at least one care- or training-related task in connection with the at least one virtual pet based on the respective care or training schedule, and subsequently monitoring the at least one user's completion of said at least one task; and upon determining that the at least one user has acquired a sufficient amount of knowledge and experience in caring for the at least one virtual pet: periodically prompting the at least one user, via the associated at least one user device, to complete at least one care- or training-related task in connection with the corresponding at least one actual pet based on the respective care or training schedule, and subsequently monitoring the at least one user's completion of said at least one task; whereby, the system is configured for first teaching the at least one user how to care for and train the at least one virtual pet so as to better ensure that the user is sufficiently prepared for and capable of subsequently caring for and training the corresponding at least one actual pet.

2. The method according to embodiment 1, further comprising further comprising the step of implementing a supervisor application residing in memory on an at least one supervisor device under the control of an at least one supervisor associated with the at least one user, the at least one supervisor device in selective communication with at least one of the computing system and the at least one user device.

3. The method according to embodiments 1-2, further comprising the step of implementing an at least one pet device attached to or otherwise worn by the at least one actual pet, the at least one pet device in selective communication with at least one of the computing system and the at least one user device.

4. The method according to embodiments 1-3, further comprising the step of implementing an at least one database in communication with the computing system and configured for selectively storing said data related to the at least one user and associated at least one actual pet.

5. The method according to embodiments 1-4, further comprising the step of positioning an at least one accessory sensor proximal an at least one object with which the actual pet commonly interacts, the at least one accessory sensor in selective communication with at least one of the computing system and the at least one user device.

6. The method according to embodiments 1-5, further comprising the step of, upon the at least one user completing the given at least one care- or training-related task in connection with the at least one virtual pet, crediting the user table of the associated user account with a pre-determined number of selectively redeemable reward points.

7. The method according to embodiments 1-6, further comprising the step of, upon the at least one user completing the given at least one care- or training-related task in connection with the at least one actual pet, crediting the user table of the associated user account with a pre-determined number of selectively redeemable reward points.

8. The method according to embodiments 1-7, further comprising the step of allowing an at least one supervisor associated with the at least one user to selectively monitor the at least one user's progress.

9. The method according to embodiments 1-8, further comprising the step of implementing a supervisor application residing in memory on an at least one supervisor device under the control of the at least one supervisor, the at least one supervisor device in selective communication with at least one of the computing system and the at least one user device.

10. The method according to embodiments 1-9, wherein the step of determining that the at least one user has acquired a sufficient amount of knowledge and experience in caring for the at least one virtual pet, further comprises the step of notifying the at least one supervisor that the at least one user is ready to care for and train the at least one actual pet.

11. The method according to embodiments 1-10, further comprising the step of, upon determining that the at least one user is not capable of completing the at least one care- or training-related task in connection with the at least one actual pet, prompting the associated at least one supervisor to complete said at least one task on behalf of the at least one user.

12. The method according to embodiments 1-11, wherein the step of determining that the at least one user has acquired a sufficient amount of knowledge and experience in caring for the at least one virtual pet, further comprises the step of updating the pet table, care schedule and training schedule as needed to correspond to the current data associated with the at least one actual pet.

13. The method according to embodiments 1-12, further comprising the step of periodically updating the pet table, care schedule and training schedule as needed to correspond to the current data associated with the at least one actual pet.

14. A method for administering a pet management system for assisting an at least one user in caring for and training an at least one actual pet, the method comprising the steps of: implementing a central computing system configured for receiving and processing data related to the at least one user and associated at least one actual pet; implementing a user application residing in memory on an at least one user device under the control of the at least one user, the at least one user device in selective communication with the computing system; implementing a supervisor application residing in memory on an at least one supervisor device under the control of an at least one supervisor associated with the at least one user, the at least one supervisor device in selective communication with at least one of the computing system and the at least one user device; establishing a user account associated with a one of the at least one user and associated at least one actual pet, the user account containing at least one of a unique account identifier, a user table containing details related to each of the at least one user associated with the user account, a supervisor table containing details related to each of the at least one supervisor associated with the user account, and a pet table containing details related to each of the at least one actual pet associated with the user account; and upon a one of the at least one user desiring to care for and train the at least one actual pet: obtaining data related to the at least one user to be stored in the user table of the associated user account; obtaining data related to the at least one actual pet to be stored in the pet table of the associated user account; automatically generating an at least one virtual pet based on the data related to the at least one actual pet contained in the pet table of the associated user account, the at least one virtual pet configured for simulating the qualities and behaviors of the associated at least one actual pet; automatically generating a care schedule based on the data contained in at least one of the pet table and user table of the associated user account, the care schedule being configured for providing the at least one user with guidance regarding various care-related tasks; automatically generating a training schedule based on the data contained in at least one of the pet table and user table of the associated user account, the training schedule being configured for providing the at least one user with guidance regarding various training-related tasks; periodically prompting the at least one user, via the associated at least one user device, to complete at least one care- or training-related task in connection with the at least one virtual pet based on the respective care or training schedule, and subsequently monitoring the at least one user's completion of said at least one task; and upon determining that the at least one user has acquired a sufficient amount of knowledge and experience in caring for the at least one virtual pet: notifying the at least one supervisor that the at least one user is ready to care for and train the at least one actual pet; and periodically prompting the at least one user, via the associated at least one user device, to complete at least one care- or training-related task in connection with the corresponding at least one actual pet based on the respective care or training schedule, and subsequently monitoring the at least one user's completion of said at least one task; whereby, the system is configured for first teaching the at least one user how to care for and train the at least one virtual pet so as to better ensure that the user is sufficiently prepared for and capable of subsequently caring for and training the corresponding at least one actual pet.

15. A pet management system for assisting an at least one user in caring for and training an at least one actual pet, the system comprising: a central computing system configured for receiving and processing data related to the at least one user and associated at least one actual pet; an at least one user device under the control of the at least one user and in selective communication with the computing system, the at least one user device providing a user application residing in memory thereon; and a user account associated with a one of the at least one user and associated at least one actual pet, the user account containing at least one of a unique account identifier, a user table containing details related to each of the at least one user associated with the user account, and a pet table containing details related to each of the at least one actual pet associated with the user account; wherein, upon a one of the at least one user desiring to care for and train the at least one actual pet, the system is configured for: obtaining data related to the at least one user to be stored in the user table of the associated user account; obtaining data related to the at least one actual pet to be stored in the pet table of the associated user account; automatically generating an at least one virtual pet based on the data related to the at least one actual pet contained in the pet table of the associated user account, the at least one virtual pet configured for simulating the qualities and behaviors of the associated at least one actual pet; automatically generating a care schedule based on the data contained in at least one of the pet table and user table of the associated user account, the care schedule being configured for providing the at least one user with guidance regarding various care-related tasks; automatically generating a training schedule based on the data contained in at least one of the pet table and user table of the associated user account, the training schedule being configured for providing the at least one user with guidance regarding various training-related tasks; periodically prompting the at least one user, via the associated at least one user device, to complete at least one care- or training-related task in connection with the at least one virtual pet based on the respective care or training schedule, and subsequently monitoring the at least one user's completion of said at least one task; and upon determining that the at least one user has acquired a sufficient amount of knowledge and experience in caring for the at least one virtual pet: periodically prompting the at least one user, via the associated at least one user device, to complete at least one care- or training-related task in connection with the corresponding at least one actual pet based on the respective care or training schedule, and subsequently monitoring the at least one user's completion of said at least one task; whereby, the system is configured for first teaching the at least one user how to care for and train the at least one virtual pet so as to better ensure that the user is sufficiently prepared for and capable of subsequently caring for and training the corresponding at least one actual pet.

16. The pet management system according to embodiment 15, further comprising an at least one supervisor device under the control of an at least one supervisor associated with the at least one user and in selective communication with at least one of the computing system and the at least one user device, the at least one supervisor device providing a supervisor application residing in memory thereon.

17. The pet management system according to embodiments 15-16, wherein the system is further configured for the step of allowing an at least one supervisor associated with the at least one user to selectively monitor the at least one user's progress.

18. The pet management system according to embodiments 15-17, wherein upon determining that the at least one user has acquired a sufficient amount of knowledge and experience in caring for the at least one virtual pet, the system is further configured for notifying the at least one supervisor that the at least one user is ready to care for and train the at least one actual pet.

19. The pet management system according to embodiments 15-18, wherein upon determining that the at least one user is not capable of completing the at least one care- or training-related task in connection with the at least one actual pet, the system is configured for prompting the associated at least one supervisor to complete said at least one task on behalf of the at least one user.

20. The pet management system according to embodiments 15-19, further comprising an at least one pet device attached to or otherwise worn by the at least one actual pet, the at least one pet device in selective communication with at least one of the computing system and the at least one user device.

21. The pet management system according to embodiments 15-20, wherein the at least one pet device is a wearable device.

22. The pet management system according to embodiments 15-21, wherein the at least one pet device is configured as a collar.

23. The pet management system according to embodiments 15-22, wherein each of the at least one user device and pet device provides an at least one GPS chip for assisting in providing the computing system with the geographic location of the respective user and actual pet in possession of each said device.

24. The pet management system according to embodiments 15-23, wherein: the at least one user device provides an at least one microphone; and the at least one pet device provides an at least one speaker; whereby, the at least one user is able to remotely transmit audible commands to the at least one actual pet.

25. The pet management system according to embodiments 15-24, wherein the at least one pet device provides an at least one vibrator configured for providing physical feedback to the at least one actual pet in the form of pleasing vibrations.

26. The pet management system according to embodiments 15-25, wherein the at least one pet device provides an at least one pet sensor capable of monitoring at least one of a pulse of the at least one actual pet, a breathing rate of the at least one actual pet, a geographic location of the at least one actual pet, a physical orientation of the at least one actual pet, a movement of the at least one actual pet, and a speed of the at least one actual pet.

27. The pet management system according to embodiments 15-26, further comprising an at least one database in communication with the computing system and configured for selectively storing said data related to the at least one user and associated at least one actual pet.

28. The pet management system according to embodiments 15-27, further comprising an at least one accessory sensor configured for being selectively positioned proximal an at least one object with which the actual pet commonly interacts, the at least one accessory sensor in selective communication with at least one of the computing system and the at least one user device.

29. The pet management system according to embodiments 15-28, wherein the at least one accessory sensor is an optical sensor.

30. The pet management system according to embodiments 15-29, wherein the at least one accessory sensor utilizes near field communication.

31. The pet management system according to embodiments 15-30, wherein the at least one accessory sensor utilizes radio frequency identification.

32. The pet management system according to embodiments 15-31, wherein the at least one user device is a wearable device.

33. The pet management system according to embodiments 15-32, wherein the at least one user device is configured as a smartwatch.

34. The pet management system according to embodiments 15-33, wherein the at least one user device provides an at least one display screen for providing an at least one graphical user interface to assist the at least one user to utilize the system.

35. The pet management system according to embodiments 15-34, wherein the at least one display screen is a touchscreen.

36. The pet management system according to embodiments 15-35, wherein upon the at least one user completing the given at least one care- or training-related task in connection with the at least one virtual pet, the system is further configured for crediting the user table of the associated user account with a pre-determined number of selectively redeemable reward points.

37. The pet management system according to embodiments 15-36, wherein upon the at least one user completing the given at least one care- or training-related task in connection with the at least one actual pet, the system is further configured for crediting the user table of the associated user account with a pre-determined number of selectively redeemable reward points.

38. The pet management system according to embodiments 15-37, wherein upon determining that the at least one user has acquired a sufficient amount of knowledge and experience in caring for the at least one virtual pet, the system is further configured for updating the pet table, care schedule and training schedule as needed to correspond to the current data associated with the at least one actual pet.

39. The pet management system according to embodiments 15-38, wherein the system is further configured for periodically updating the pet table, care schedule and training schedule as needed to correspond to the current data associated with the at least one actual pet.

In closing, regarding the exemplary embodiments of the present invention as shown and described herein, it will be appreciated that a pet management system and associated methods are disclosed for teaching and assisting a user in caring for and training a pet. Because the principles of the invention may be practiced in a number of configurations beyond those shown and described, it is to be understood that the invention is not in any way limited by the exemplary embodiments, but is generally directed to a pet management system apparatus and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for administering a pet management system for assisting an at least one user in caring for and training an at least one actual pet, the method comprising the steps of:
implementing a central computing system configured for receiving and processing data related to the at least one user and associated at least one actual pet;
implementing a user application residing in memory on an at least one user device under the control of the at least one user, the at least one user device in selective communication with the computing system;
establishing a user account associated with a one of the at least one user and associated at least one actual pet, the user account containing at least one of a unique account identifier, a user table containing details related to each of the at least one user associated with the user account, and a pet table containing details related to each of the at least one actual pet associated with the user account; and
upon a one of the at least one user desiring to care for and train the at least one actual pet:
obtaining data related to the at least one user to be stored in the user table of the associated user account;
obtaining data related to the at least one actual pet to be stored in the pet table of the associated user account;
automatically generating an at least one virtual pet based on the data related to the at least one actual pet contained in the pet table of the associated user account, the at least one virtual pet configured for simulating the qualities and behaviors of the associated at least one actual pet;
automatically generating a care schedule based on the data contained in at least one of the pet table and user table of the associated user account, the care schedule being configured for providing the at least one user with guidance regarding various care-related tasks;
automatically generating a training schedule based on the data contained in at least one of the pet table and user table of the associated user account, the training schedule being configured for providing the at least one user with guidance regarding various training-related tasks;
periodically prompting the at least one user, via the associated at least one user device, to complete at least one care- or training-related task in connection with the at least one virtual pet based on the respective care or training schedule, and subsequently monitoring the at least one user's completion of said at least one task; and
upon determining that the at least one user has acquired a sufficient amount of knowledge and experience in caring for the at least one virtual pet:
periodically prompting the at least one user, via the associated at least one user device, to complete at least one care- or training-related task in connection with the corresponding at least one actual pet based on the respective care or training schedule, and subsequently monitoring the at least one user's completion of said at least one task;
whereby, the system is configured for first teaching the at least one user how to care for and train the at least one virtual pet so as to better ensure that the user is sufficiently prepared for and capable of subsequently caring for and training the corresponding at least one actual pet.

2. The method of claim 1, further comprising the step of implementing a supervisor application residing in memory on an at least one supervisor device under the control of an at least one supervisor associated with the at least one user, the at least one supervisor device in selective communication with at least one of the computing system and the at least one user device.

3. The method of claim 1, further comprising the step of implementing an at least one pet device attached to or otherwise worn by the at least one actual pet, the at least one pet device in selective communication with at least one of the computing system and the at least one user device.

4. The method of claim 1, further comprising the step of implementing an at least one database in communication with the computing system and configured for selectively storing said data related to the at least one user and associated at least one actual pet.

5. The method of claim 1, further comprising the step of positioning an at least one accessory sensor proximal an at least one object with which the actual pet commonly interacts, the at least one accessory sensor in selective communication with at least one of the computing system and the at least one user device.

6. The method of claim 1, further comprising the step of, upon the at least one user completing the given at least one care- or training-related task in connection with the at least one virtual pet, crediting the user table of the associated user account with a pre-determined number of selectively redeemable reward points.

7. The method of claim 1, further comprising the step of, upon the at least one user completing the given at least one care- or training-related task in connection with the at least one actual pet, crediting the user table of the associated user account with a pre-determined number of selectively redeemable reward points.

8. The method of claim 1, further comprising the step of allowing an at least one supervisor associated with the at least one user to selectively monitor the at least one user's progress.

9. The method of claim 8, further comprising the step of implementing a supervisor application residing in memory on an at least one supervisor device under the control of the at least one supervisor, the at least one supervisor device in selective communication with at least one of the computing system and the at least one user device.

10. The method of claim 8, wherein the step of determining that the at least one user has acquired a sufficient amount of knowledge and experience in caring for the at least one virtual pet, further comprises the step of notifying the at least one supervisor that the at least one user is ready to care for and train the at least one actual pet.

11. The method of claim 8, further comprising the step of, upon determining that the at least one user is not capable of completing the at least one care- or training-related task in connection with the at least one actual pet, prompting the associated at least one supervisor to complete said at least one task on behalf of the at least one user.

12. The method of claim 1, wherein the step of determining that the at least one user has acquired a sufficient amount of knowledge and experience in caring for the at least one virtual pet, further comprises the step of updating the pet table, care schedule and training schedule as needed to correspond to the current data associated with the at least one actual pet.

13. The method of claim 1, further comprising the step of periodically updating the pet table, care schedule and training schedule as needed to correspond to the current data associated with the at least one actual pet.

14. A method for administering a pet management system for assisting an at least one user in caring for and training an at least one actual pet, the method comprising the steps of:
implementing a central computing system configured for receiving and processing data related to the at least one user and associated at least one actual pet;
implementing a user application residing in memory on an at least one user device under the control of the at least one user, the at least one user device in selective communication with the computing system;
implementing a supervisor application residing in memory on an at least one supervisor device under the control of an at least one supervisor associated with the at least one user, the at least one supervisor device in selective communication with at least one of the computing system and the at least one user device;
establishing a user account associated with a one of the at least one user and associated at least one actual pet, the user account containing at least one of a unique account identifier, a user table containing details related to each of the at least one user associated with the user account, a supervisor table containing details related to each of the at least one supervisor associated with the user account, and a pet table containing details related to each of the at least one actual pet associated with the user account; and
upon a one of the at least one user desiring to care for and train the at least one actual pet:
obtaining data related to the at least one user to be stored in the user table of the associated user account;
obtaining data related to the at least one actual pet to be stored in the pet table of the associated user account;
automatically generating an at least one virtual pet based on the data related to the at least one actual pet contained in the pet table of the associated user account, the at least one virtual pet configured for simulating the qualities and behaviors of the associated at least one actual pet;
automatically generating a care schedule based on the data contained in at least one of the pet table and user table of the associated user account, the care schedule being configured for providing the at least one user with guidance regarding various care-related tasks;
automatically generating a training schedule based on the data contained in at least one of the pet table and user table of the associated user account, the training schedule being configured for providing the at least one user with guidance regarding various training-related tasks;
periodically prompting the at least one user, via the associated at least one user device, to complete at least one care- or training-related task in connection with the at least one virtual pet based on the respective care or training schedule, and subsequently monitoring the at least one user's completion of said at least one task; and
upon determining that the at least one user has acquired a sufficient amount of knowledge and experience in caring for the at least one virtual pet:
notifying the at least one supervisor that the at least one user is ready to care for and train the at least one actual pet; and
periodically prompting the at least one user, via the associated at least one user device, to complete at least one care- or training-related task in connection with the corresponding at least one actual pet based on the respective care or training schedule, and subsequently monitoring the at least one user's completion of said at least one task;
whereby, the system is configured for first teaching the at least one user how to care for and train the at least one virtual pet so as to better ensure that the user is sufficiently prepared for and capable of subsequently caring for and training the corresponding at least one actual pet.

15. A pet management system for assisting an at least one user in caring for and training an at least one actual pet, the system comprising:
a central computing system configured for receiving and processing data related to the at least one user and associated at least one actual pet;
an at least one user device under the control of the at least one user and in selective communication with the computing system, the at least one user device providing a user application residing in memory thereon; and
a user account associated with a one of the at least one user and associated at least one actual pet, the user account containing at least one of a unique account identifier, a user table containing details related to each of the at least one user associated with the user account, and a pet table containing details related to each of the at least one actual pet associated with the user account;
wherein, upon a one of the at least one user desiring to care for and train the at least one actual pet, the system is configured for:
obtaining data related to the at least one user to be stored in the user table of the associated user account;
obtaining data related to the at least one actual pet to be stored in the pet table of the associated user account;
automatically generating an at least one virtual pet based on the data related to the at least one actual pet contained in the pet table of the associated user account, the at least one virtual pet configured for simulating the qualities and behaviors of the associated at least one actual pet;
automatically generating a care schedule based on the data contained in at least one of the pet table and user table of the associated user account, the care schedule being configured for providing the at least one user with guidance regarding various care-related tasks;
automatically generating a training schedule based on the data contained in at least one of the pet table and user table of the associated user account, the training schedule being configured for providing the at least one user with guidance regarding various training-related tasks;
periodically prompting the at least one user, via the associated at least one user device, to complete at least one care- or training-related task in connection with the at least one virtual pet based on the respective care or training schedule, and subsequently monitoring the at least one user's completion of said at least one task; and
upon determining that the at least one user has acquired a sufficient amount of knowledge and experience in caring for the at least one virtual pet:
periodically prompting the at least one user, via the associated at least one user device, to complete at least one care- or training-related task in connection with the corresponding at least one actual pet based on the respective care or training schedule, and subsequently monitoring the at least one user's completion of said at least one task;
whereby, the system is configured for first teaching the at least one user how to care for and train the at least one virtual pet so as to better ensure that the user is sufficiently prepared for and capable of subsequently caring for and training the corresponding at least one actual pet.

16. The pet management system of claim 15, further comprising an at least one supervisor device under the control of an at least one supervisor associated with the at least one user and in selective communication with at least one of the computing system and the at least one user device, the at least one supervisor device providing a supervisor application residing in memory thereon.

17. The pet management system of claim 15, further comprising an at least one pet device attached to or otherwise worn by the at least one actual pet, the at least one pet device in selective communication with at least one of the computing system and the at least one user device.

18. The pet management system of claim 17, wherein:
the at least one user device provides an at least one microphone; and
the at least one pet device provides an at least one speaker;
whereby, the at least one user is able to remotely transmit audible commands to the at least one actual pet.

19. The pet management system of claim 15, further comprising an at least one database in communication with the computing system and configured for selectively storing said data related to the at least one user and associated at least one actual pet.

20. The pet management system of claim 15, further comprising an at least one accessory sensor configured for being selectively positioned proximal an at least one object with which the actual pet commonly interacts, the at least one accessory sensor in selective communication with at least one of the computing system and the at least one user device.
